(19) United States
(12) Patent Application Publication
(10) Pub. No.: US 2011/0161925 A1
(43) Pub. Date: Jun. 30, 2011

(54) METHOD AND ELECTRONIC DEVICE FOR GENERATING A GRAPHICAL REPORT

(75) Inventors: CHI-CHIH WANG, Tu-Cheng (TW); YONG-HUA SONG, Shenzhen City (CN); YA-QUAN LI, Shenzhen City (CN); YU-JIE LI, Shenzhen City (CN)

(73) Assignees: GDS SOFTWARE (SHENZHEN) CO.,LTD, ShenZhen City (CN); HON HAI PRECISION INDUSTRY CO., LTD., Tu-Cheng (TW)

(21) Appl. No.: 12/848,215

(22) Filed: Aug. 1, 2010

(30) Foreign Application Priority Data
Dec. 29, 2009 (CN) 200910312623.1

(51) Int. Cl. G06F 9/44

(52) U.S. Cl. 717/109

(57) ABSTRACT

An electronic device and method generates a customized graphical report. The electronic device reads and parses Extensible Markup Language (XML) files to obtain objects that control configurations of the graphical report. The electronic device uses defined control objects to pre-compile the configuration objects parsed from the XML files into report control objects. The electronic device fills the report control objects in Integrated Development Environment (IDE) to generate the graphical report.

### BACKGROUND

1. Technical Field

Embodiments of the present disclosure relate to user interfaces, and more particularly to a method and system for displaying a graphical report.

2. Description of Related Art

In order for corporate operations to maintain manageability while dealing with complex financial and commercial conditions, accurate and timely reporting systems are essential. Considerable manpower and fiscal resources are required to support such systems. Generation and delivery of pertinent data, while taking advantage of recently-developed communication technologies, continues to present certain obstacles. One such impediment is the reporting systems' inability to implement changes to attributes without rewriting source code, thereby expending considerable time and money.

### BRIEF DESCRIPTION OF THE DRAWINGS

FIG. 1 is a block diagram of one embodiment of an electronic device for generating a graphical report.

FIG. 2 is a flowchart illustrating one embodiment of a method for generating a graphical report.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as software and/or hardware unit and may be stored in any type of computer-readable medium or other computer storage electronic device.

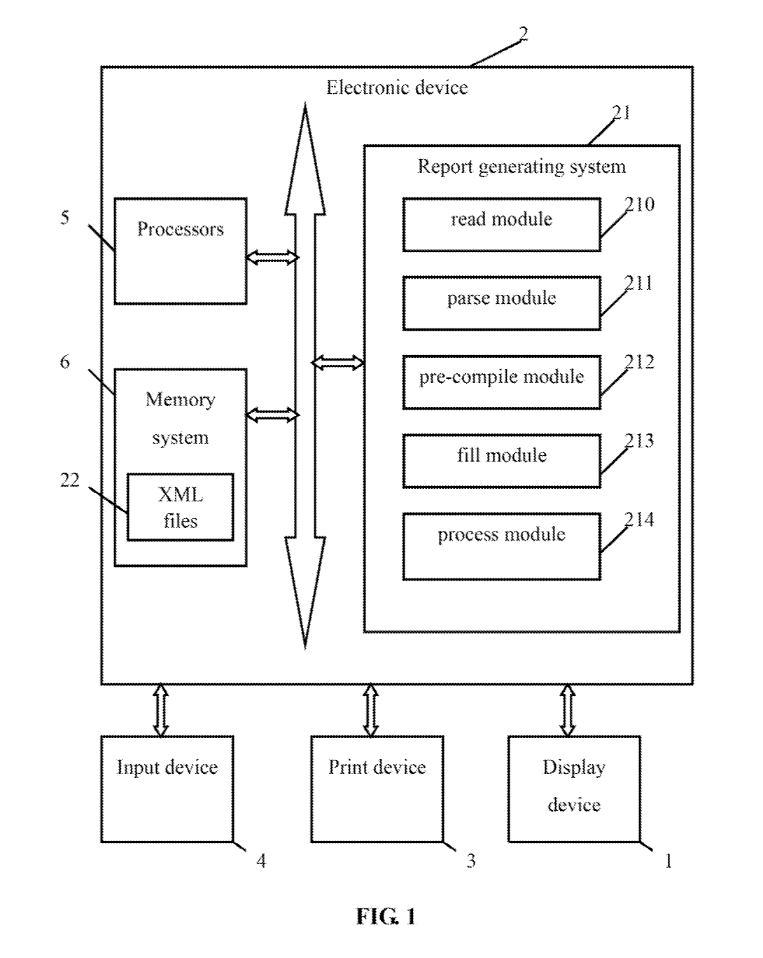

FIG. 1 is a block diagram of one embodiment of an electronic device 2 comprising a memory system 6 to store Extensible Markup Language (XML) files 22, and a report generating system 21 to generate graphical reports. The electronic device 2 is electronically connected with peripheral devices including a display device 1 to display the generated graphical reports, a print device 3 to output the generated graphical reports, and an input device 4 to conduct data registration of the report generating system 21. Depending on the embodiment, the electronic device 2 can be a personal computer or a workstation, for example.

The system 21 includes a read module 210, a parse module 211, a pre-compile module 212, a fill module 213 and a process module 214. One or more computerized codes of the modules 210-212 are stored in the memory system 6 and executed by one or more processors 5. In the embodiment, the read module 210 reads the XML files 22 from the memory system 20. The parse module 211 loads the XML files 22 into the memory system 20 and parses the XML files 22 to obtain Report Configuration Objects. The Report Configuration Objects are objects defined in the XML files 22 to describe attributes, such as types and names. The pre-compile module 212 pre-compiles the Report Configuration Objects based on a User Control to generate a

Report Control. Users can adjust attributes of the graphical report on demand using the User Control. In the embodiment, the Report Control is an assembly of objects for visualization control and the User Control is an assembly of objects for user defined control. The input device 4 is operable to manipulate the Report Control and the User Control by modifying object members via member functions thereof.

The fill module 213 fills an Integrated Development Environment (IDE) Control with the Report Control to generate a graphical report. In the embodiment, the IDE Control is an assembly of applications in a programming development environment, including code editors, compilers, debuggers and graphic user interfaces. The IDE Control can execute alone or with other applications. New features can be expanded under protocols by packaging into components that can be dynamically imported by .NET reflection technology. In the embodiment, the .NET reflection technology is implemented by .NET Runtime Framework.

The process module 214 deploys the .NET reflection technology to dynamically import the graphical report for leading out, printing, display or storage. In the embodiment, the process module 214 can lead out the graphical report to multiple file formats, such as PDF, PPT, WORD and EXCEL. Such feature is implemented by integrating PDF, PPT, WORD and EXCEL development elements and encapsulating the development elements into the User Control. The Report Control generated by the User Control thereby provides lead-out selection. In the embodiment, the process module 214 uses WebBrowser Print Control to publish the graphical report as a web document. The WebBrowser Print Control includes an assembly of printing control objects which support What You See Is What You Get (WYSIWYG), page setup, and continuous printing. In the embodiment, the process module 214 uses Office Web Components (OWC) combining XML technology to output the graphical report as bar charts, line charts, radar maps, Gantt charts, and/or three-dimensional graphics.

In the embodiment, the process module 214 uses ADO.NET, Java Data Base Connectivity(JDBC)and Component Object Model(COM)components combining XML technology to store the graphical report on the memory system 20. The storage can be implemented with Databases, such as My SQL, Oracle, DB2 and/or SQL Server. When multiple Databases are employed, a configuration file is implemented to specify which Database is in use. Editing the configuration file can change Databases without modifying system source codes.

In other embodiments, the COM components can be used to encapsulate the system 21 into a binary code. The binary code is supported by different Web Application Development Platform, such as ASP, ASP.NET, JAVA and PHP, in order to efficiently port the system 21 onto different Operating Systems.

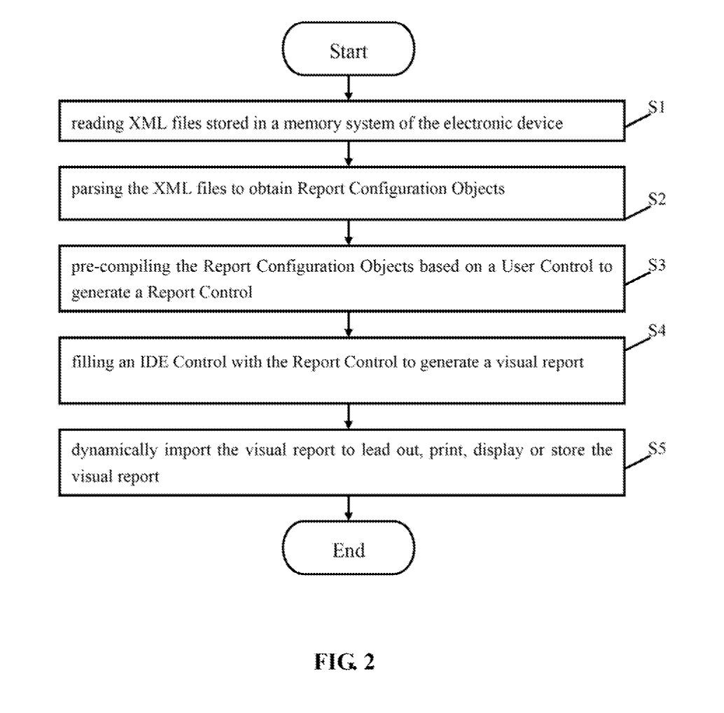

FIG. 2 is a flowchart of one embodiment of a method for generating a graphical report. Depending on the embodiments, additional blocks may be added, others removed, and the ordering of the blocks may be changed.

In block S1, the read module 210 reads the XML files 22 from the memory system 20. In block S2, the parse module 211 loads the XML files 22 into the memory system 20 and parses the XML files 22 to obtain the Report Configuration Objects. In block S3, the pre-compile module 212 pre-compiles the Report Configuration Objects to generate the Report Control. In block S4, the fill module 213 fills the IDE Control with the Report Control to generate the graphical report. In block S5, the process module 214 dynamically imports the graphical report for leading out, printing, display or storage.

Although certain inventive embodiments of the present disclosure have been specifically described, the present disclosure is not to be construed as being limited thereto. Various changes or modifications may be made to the present disclosure without departing from the scope and spirit of the present disclosure

What is claimed is:

1. An electronic device for generating graphical reports, the electronic device comprising:
a memory system;
one or more processors; and
one or more programs stored in the memory system configured to be executed by the one or more processors, the one or more programs comprising:
a read module to read Extensible Markup Language (XML) files stored in the memory system;
a parse module to parse the XML files to obtain Report Configuration Objects;
a pre-compile module to pre-compile the Report Configuration Objects based on a User Control to generate a Report Control;
a fill module to fill an Integrated Development Environment (IDE) Control with the Report Control to generate a graphical report; and
a process module to dynamically import the graphical report to lead out, print, display or store the graphical report;
wherein the Report Configuration Objects are objects defined in the XML files to define attributes, the Report Control is an assembly of objects for visualization control, the User Control is an assembly of objects for user defined control, and the IDE Control is an assembly of applications in a programming development environment.

2. The electronic device as claimed in claim 1, wherein the process module leads out the graphical report to a predetermined file format by encapsulating the development elements of the predetermined file format into the User Control.

3. The electronic device as claimed in claim 1, wherein the process module prints the graphical report in a What You See Is What You Get (WYSIWYG) mode with page setup and continuous printing support.

4. The electronic device as claimed in claim 1, wherein the process module integrates ADO.NET, Java Data Base Connectivity (JDBC) and Component Object Model (COM) components and XML technology to store the graphical report.

5. The electronic device as claimed in claim 4, the process module is capable of storing the graphical report in a plurality of types of Databases.

6. The electronic device as claimed in claim 1, wherein the electronic device comprises an input device to manipulate the User Control and the Report Control.

7. A computer-implemented method of an electronic device for generating visual report, comprising steps:
reading XML files stored in a memory system of the electronic device;
parsing the XML files to obtain Report Configuration Objects;
pre-compiling the Report Configuration Objects based on a User Control to generate a Report Control;
filling an IDE Control with the Report Control to generate a graphical report;
dynamically importing the graphical report;
leading out the graphical report to a predetermined file format;
printing the graphical report with a peripheral printing device of the electronic device;
displaying the graphical report; and
storing the graphical report.

8. The computer-implemented method as claimed in claim 7, wherein the step of leading out the graphical report is implemented by encapsulating the development elements of the predetermined file format into the User Control.

9. The computer-implemented method as claimed in claim 7, wherein the step of printing the graphical report is published in What You See Is What You Get (WYSIWYG) style mode with page setup and continuous printing support.

10. The computer-implemented method as claimed in claim 7, wherein the step of storing integrates ADO.NET, Java Data Base Connectivity (JDBC) and Component Object Model (COM) components and XML technology.

11. The computer-implemented method as claimed in claim 10, the step of storing is capable of being implemented in a plurality of types of Databases.

12. The computer-implemented method as claimed in claim 7, wherein the User Control and the Report Control are manipulated by an input device of the electronic device.

13. A computer readable storage medium having stored therein instructions, that when executed by an electronic device, cause the device to:
read XML files stored in a memory system of the electronic device;
parse the XML files to obtain Report Configuration Objects;
pre-compile the Report Configuration Objects based on a User Control to generate a Report Control;
fill an IDE Control with the Report Control to generate a graphical report;
import the graphical report dynamically;
lead out the graphical report to a predetermined file format;
print the graphical report with a peripheral printing device of the electronic device;
display the graphical report; and
store the graphical report.

14. The computer readable storage medium as claimed in claim 13, wherein the operation of leading out the graphical report is implemented by encapsulating the development elements of the predetermined file format into the User Control.

15. The computer readable storage medium as claimed in claim 13, wherein the operation of printing the graphical report is published in What You See Is What You Get (WYSIWYG) mode with page setup and continuous printing support.

16. The computer readable storage medium as claimed in claim 13, wherein the operation of storing integrates ADO.NET, Java Data Base Connectivity (JDBC) and Component Object Model (COM) components and XML technology.

17. The computer readable storage medium as claimed in claim 16, the operation of storing is capable of being implemented in a plurality of types of Databases.

18. The computer readable storage medium as claimed in claim 13, wherein the User Control and the Report Control are manipulated by an input device of the electronic device.
